(19) United States
(12) Patent Application Publication
(10) Pub. No.: US 2008/0203725 A1
(43) Pub. Date: Aug. 28, 2008

(54) Air-Gap Insulated Motor Vehicle Exhaust Duct

(75) Inventor: Winfried Willeke, Attendorf (DE)

Correspondence Address: PAMELA A. KACHUR, 950 W 450 S, BLDG. 4, COLUMBUS, IN, 47201, US

(73) Assignee: Emcon Technologies Germany (Augsburg) GMBH, Augsburg (DE)

(21) Appl. No.: 11/913,832

(22) PCT Filed: Mar. 30, 2006
(86) PCT No.: PCT/EP06/02887

§ 371 Date: Jan. 10, 2008

(30) Foreign Application Priority Data
May 12, 2005 (DE) 10 2005 022 114.9

(51) Int. Cl. F16L 9/18; F01N 7/08; F16L 19/00

(52) U.S. Cl. 285/123.6; 138/113; 60/322; 138/109

(57) ABSTRACT

An air-gap insulated vehicle exhaust duct has an outer pipe and an inner pipe, between which an air gap is formed. One of the two pipes has a flange fitted thereto, a seal being arranged between the flange and the other pipe, the seal largely sealing the air gap against the outside and, in addition, allowing relative axial and radial movement between the flange and the other pipe when thermal expansion occurs while driving.

The present invention relates to an air-gap insulated vehicle exhaust duct including an outer pipe and at least one exhaust gas carrying inner pipe which is arranged in and radially spaced from the outer pipe, and a flange which is attached to an end of a first one of the two pipes, the second one of the two pipes being adapted to perform a movement relative to the flange.

Air-gap insulated vehicle exhaust ducts of this type are used in particular in the manifold region. They offer the advantage that the thermal stress on the outer pipe, which usually constitutes the mechanically load-bearing part, is reduced in comparison with a single-walled design.

The inner pipe needs to be movable in relation to the outer pipe in order to be able to compensate for the different thermal stresses associated with the different thermal expansions of the pipes. The term “inner pipe” should be understood to mean an inner conduit and is not limited to a singular peripherally closed pipe.

It is the object of the present invention to further reduce the thermal stress that is exerted on the outer pipe.

In a vehicle exhaust duct of the type initially mentioned this is achieved in that a seal is provided between the flange and the second pipe, the seal allowing relative axial and radial movement between the flange and the second pipe.

The seal at least largely closes the annular gap provided hitherto at the downstream end of the inner pipe between the inner and outer pipes. But the seal is not configured so as to render the outer and inner pipes immovable in relation to each other; rather, it continues to permit relative movement of the pipes at this end, more particularly both in the axial and in the radial direction. The amount of exhaust gas which can enter into the air gap between the inner and outer pipes via the annular gap and thermally stresses the outer pipe is negligible by the invention.

The seal is preferably accommodated in a peripheral groove from which it projects to engage the second pipe. In particular, the peripheral groove provides for the seal to be securely positioned.

In accordance with the preferred embodiment, the seal is a slotted ring, similar to a piston ring. This design allows the seal to readily snap into a groove or to be placed onto a pipe with a permanent bias.

Preferably, the ring is made of a stiff or, in other words, non-rubber elastic material, more particularly metal. Such an embodiment, on the one hand, prevents the seal and the pipe that is movable relative to it from sticking together at high temperatures and, on the other hand, the sliding friction occurring in the axial or radial movement is reduced.

The seal should preferably be seated in the groove with radial clearance. This means that it is firmly fitted on the second pipe in the radial direction and moves in the groove together with this pipe, as is the case with a piston ring, for example. This allows a radial expansion of the seal and a radial mobility of the second pipe in relation to the first pipe.

A further improvement in the sealing effect may be obtained if the seal is in engagement with the second pipe without radial clearance.

In accordance with the preferred embodiment, the first pipe is the outer pipe, so that the flange serves to fasten the outer, mechanically load-bearing pipe.

As already explained at the outset, the vehicle exhaust duct is more particularly curved, which ensures that the greater longitudinal expansion (due to the higher temperatures in operation) of the inner pipe on its differently oriented sections is divided up into an axial and a radial displacement of the free end of the inner pipe in the region of the seal.

A further embodiment of the invention makes provision that the inner pipe is divided to form at least two exhaust gas channels opening out next to each other. In other words: the inner pipe channel has a plurality of branches with individual pipes or individual channels which together constitute the inner pipe or the inner pipe channel.

Further features and advantages of the invention will become apparent from the description below and from the accompanying drawings, to which reference is made.

In the drawings:

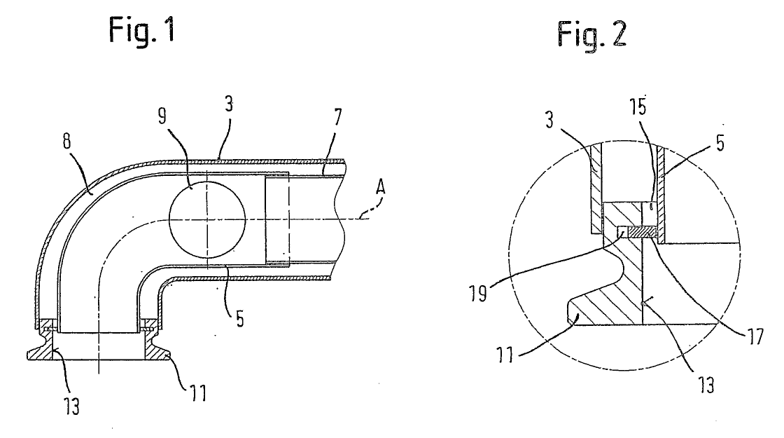

FIG. 1 shows a longitudinal sectional view of the downstream end of an exhaust duct according to the invention;

FIG. 2 shows an enlarged view of the exhaust duct according to FIG. 1 in the area of the flange;

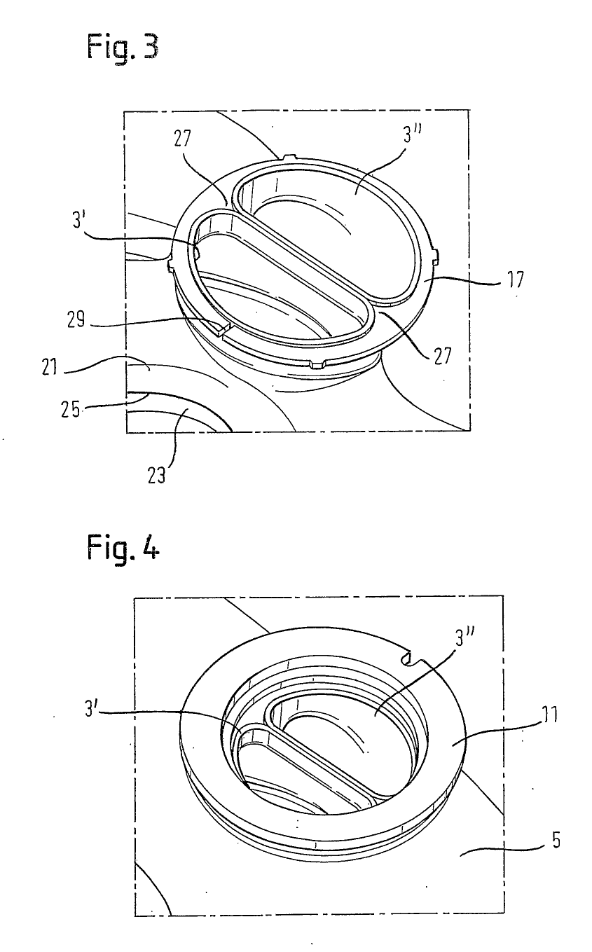

FIG. 3 shows a perspective top view of the downstream end of the inner pipe of a vehicle exhaust duct according to a second embodiment of the invention; and

FIG. 4 shows a perspective top view of the downstream end of the vehicle exhaust duct containing the inner pipe according to FIG. 3.

FIG. 1 shows an air-gap insulated vehicle exhaust duct in the form of a manifold, only the downstream end being illustrated. The visible outer skin of the exhaust duct is formed by an outer pipe 3 which may also be composed of shells connected at the edges. Arranged inside the outer pipe 3 is an inner pipe 5 which, as related to the center line A of the duct, is radially spaced away from the pipe 3 all around and is arranged essentially coaxially therewith. The inner pipe 5 has an additional inner pipe 7 inserted therein which extends toward the inlet end (not shown) of the exhaust duct. An air gap 8 in the shape of a ring channel is produced between the pipes 5, 7 and the pipe 3. The pipe 5 has an orifice 9 into which a laterally extending, further inner pipe (not visible) opens which is associated with a different cylinder chamber and likewise runs within the pipe 3.

As shown in FIG. 1, the pipes 3, 5 are bent transversely to the axis A through roughly 90 degrees, so that the exhaust duct runs in a curved shape. A flange 11 is non-displaceably attached to the pipe 3 at the downstream end of the exhaust duct, such as by welding or brazing. The flange 11 has a flow-through opening 13 into which the downstream end of the pipe 5 protrudes.

FIG. 2 shows the downstream end of the exhaust duct in detail. It can be clearly seen here that the diameter of the flow-through opening 13 is larger than the outer diameter of the pipe 5, so that an annular gap 15 is produced between these components. This annular gap 15 is closed so as to be largely gastight by a seal 17 in the form of a sealing ring, so that the exhaust gas can not enter into the air gap 8 between the pipes 3, 5 through the annular gap 15. The seal 17 is a slotted ring which is accommodated for movement in the radial direction in a groove 19 which has an exact fit in the axial direction. To this end, a gap is provided between the groove base (deepest point of the groove) and the outside of the seal 17. In the axial direction, the seal 17 is accommodated in the groove 19 with almost no clearance.

The seal 17 is in engagement with the outer periphery of the pipe 5 by a completely or almost completely closed periphery. The seal 17 is in the form of a non-rubber elastic ring made of a stiff material, in particular of metal.

The mounting of the ring and the groove permits an axial and a radial movement of the downstream end of the pipe 5 relative to the pipe 3 by the pipe 5 being adapted to slide along the seal 17 in the axial direction and, in the case of a radial movement, taking the seal 17 along.

The embodiment according to FIGS. 3 and 4 substantially corresponds to that mentioned above, so that only the differences will be discussed below and those parts that are identical in function are denoted by the reference numbers already introduced.

In the embodiment according to FIG. 3, the inner pipe 3 or the inner conduit is composed of two individual pipes 3′, 3″ which are functionally connected in parallel or is divided into two individual pipes 3′, 3″. These individual pipes 3′, 3″ are formed by at least two shells 21, 23 which are connected with each other along their edges 25. The two individual pipes 3′, 3″ constitute exhaust gas channels and carry the exhaust gas from various cylinders through a common outer pipe 5 which may likewise be assembled from shells. The D-shaped downstream ends of the individual pipes 3′, 3″ are connected with each other along their flat faces and open into the flange 11. The seal 17, resting against the individual pipes 3′, 3″, exactly follows the course of the assembled outer contour and has extensions 27 penetrating into a tapering intermediate space between the pipes. The slot 29 can also be clearly seen here. This slot 29 may also be present in the installed condition to ensure a constant pretension of the sealing ring on the inner pipe 3.

In FIG. 4 the flange 11 and the outer pipe 5 can be seen.

1-13. (canceled)

14. An air-gap insulated vehicle exhaust duct, comprising:
an outer pipe,
at least one exhaust gas carrying inner pipe positioned in and radially spaced from the outer pipe,
a flange attached to an end of a first one of the two pipes, the second one of the two pipes being movable relative to the flange, and
a seal positioned between the flange and the second pipe, the seal allowing relative axial and radial movement between the flange and the second pipe.

15. The vehicle exhaust duct according to claim 14, wherein an annular gap is provided between the second pipe and the flange, the annular gap being at least largely closed by the seal.

16. The vehicle exhaust duct according to claim 14, wherein the seal is accommodated in and projects from a peripheral groove.

17. The vehicle exhaust duct according to claim 14, wherein the seal is a slotted ring.

18. The vehicle exhaust duct according to claim 17, wherein the seal is made of a non-rubber elastic material.

19. The vehicle exhaust duct according to claim 17, wherein the seal is made of metal.

20. The vehicle exhaust duct according to claim 16, wherein the seal is seated in the groove with radial clearance.

21. The vehicle exhaust duct according to claim 14, characterized in that the seal is in engagement with the second pipe without radial clearance.

22. The vehicle exhaust duct according to claim 14, wherein the first pipe is the outer pipe.

23. The vehicle exhaust duct according to claim 14, wherein the vehicle exhaust duct has a curved shape.

24. The vehicle exhaust duct according to claim 14, wherein the inner pipe is divided to form at least two exhaust gas channels.

25. The vehicle exhaust duct according to claim 24, wherein the inner pipe is composed of individual pipes connected in parallel.

26. The vehicle exhaust duct according to claim 24, wherein the inner pipe is composed of individual pipes which are D-shaped in cross-section and are adjacent to each other at their flat faces.

27. The vehicle exhaust duct according to claim 14, wherein the inside of the seal rests against the inner pipe, following the outer contour thereof.
